(19) United States
(12) Patent Application Publication
(10) Pub. No.: US 2023/0323914 A1
(43) Pub. Date: Oct. 12, 2023

(54) TAPERED ROLLER BEARING AND DIFFERENTIAL GEAR WITH A TAPERED ROLLER BEARING

(71) Applicant: AKTIEBOLAGET SKF, GOTEBORG (SE)

(72) Inventor: Padelis Katsaros, Schweinfurt (DE)

(21) Appl. No.: 18/127,084

(22) Filed: Mar. 28, 2023

(30) Foreign Application Priority Data
Apr. 6, 2022 (DE) 102022203419.8

(51) Int. Cl. F16C 19/36

(52) U.S. Cl. CPC F16C 19/364; F16C 2361/61

(57) ABSTRACT

A tapered roller bearing has a first ring having a first raceway, a second ring having a second raceway and a plurality of tapered rollers between and configured to roll on the first and second raceways. The first ring includes a guide flange configured to guide the tapered rollers and an undercut at a junction of the first raceway and the guide flange, and the undercut defines an axial length of a free-standing portion of the guide flange that is not radially supported by the material of the first ring. The guide flange also includes a guide portion having a contact surface configured to contact the tapered rollers, the contact surface having a radially inner end at the undercut and a radially outer end, and a reinforcing portion located radially outward of the radially outer end of the contact surface. The reinforcing portion radially reinforces the guide portion.

### CROSS-REFERENCE

This application claims priority to German patent application no. 10 2022 203 419.8 filed on Apr. 6, 2022, the contents of which are fully incorporated herein by reference.

### TECHNOLOGICAL FIELD

The present disclosure is directed to a tapered roller bearing having a reinforced flange and to a differential gear, in particular a rear axle drive, with such a tapered roller bearing.

### BACKGROUND

Tapered roller bearings are rolling bearings in which the rolling elements used are tapered rollers and in which the raceways of the inner and outer rings are conical. This conical geometry results in a linear contact between the rollers and the raceways that permits greater loads than ball bearings. In particular, tapered roller bearings allow the support of combined loads, i.e. radial and axial loads. To prevent the tapered rollers from jumping out of the bearing at their larger end, a guide flange is usually provided on the inner ring to guide the tapered rollers, with the larger end of the tapered rollers resting against the guide flange. To allow the raceway to be manufactured on the inner ring, an undercut is provided between the raceway and the guide flange.

In vehicles, tapered roller bearings are frequently used for locations in which the bearings are subjected to high combined loads, such as in a pinion shaft bearing arrangement in rear axle drives of trucks. In this case, the tapered roller bearings support the applied loads and distribute them among their raceways and guide flanges, the guide flanges particularly supporting a portion of the loads acting in a radial direction. This means that the magnitude of the loads or forces acting on the bearing and its components depends on the one hand on the magnitude of the external loads and on the other hand on the individual geometries of the tapered roller bearing itself. In particular, the amount of load acting on the guide flange depends on a taper angle of the roller. The radial and axial components of this load depend on the taper angle of the raceway. If the load on the flange exceeds certain limits, the flange may break in extreme cases, resulting in bearing failure.

To prevent breakage of the guide flange, it is known to reinforce and/or support the guide flange in the axial direction and/or to optimize a radius of the undercut between the guide flange and raceway. Other known measures include modifying and/or adapting the material properties by optimized heat treatments in which an attempt is made to achieve an optimum compromise between toughness and wear resistance or hardness of the guide flange or inner ring.

### SUMMARY

It is therefore an aspect of the present disclosure to provide an improved tapered roller bearing in which the risk of guide flange fracture is reduced.

In the following, a tapered roller bearing, in particular for a differential gear of a vehicle is provided. The differential gear may be a rear axle drive in which the tapered roller bearing may be inserted, for example, in a pinion shaft bearing of the rear axle drive. The tapered roller bearing includes at least one first ring having a first raceway, at least one second ring having a second raceway, and at least one row of tapered rollers rolling on the first and second raceways. In this regard, the at least one first ring includes a guide flange configured to guide the tapered rollers. In particular, the first ring can be an inner ring. In order to form the raceway on the at least one first ring, an undercut or recess can be provided between the raceway and the guide flange, which allows a raceway surface to be machined. In particular, the undercut determines an axial length of a free-standing region of the guide flange that is not radially supported by the material of the first ring. Further, an angle of the first raceway to an axis of rotation of the tapered roller bearing may be greater than 20°, preferably greater than 25°, most preferably greater than 30°.

To reduce the risk of breakage of the guide flange, the guide flange has a guide portion providing a contact surface with the tapered rollers and a reinforcing portion that does not contact the tapered rollers, the reinforcing portion radially reinforcing the guide flange. The reinforcing portion, which radially reinforces the guide flange, can in particular reduce a local stress concentration in the region of the undercut, thereby reducing the risk of breakage of the guide flange. Furthermore, in contrast to an axial installation space for the guide flange, the radial installation space available for the guide flange is usually free so that reinforcement or thickening of the guide flange in the radial direction is usually unproblematic.

The fact that the reinforcing portion radially reinforces the guide flange avoids the need to increase the axial installation space of the tapered roller bearing. This means that the tapered roller bearing described above can be used in existing bearing arrangements without having to redesign the configuration of the bearing arrangement. Of course, the above-described reinforcing portion of the guide flange also allows the axial thickness of the guide flange to be reduced and compensated for by the radial reinforcement so that the stability and/or strength of the guide flange is maintained even when the installation space is limited axially.

Preferably, the reinforcing portion extends at least over the free-standing region of the guide flange above the raceway so that the reinforcing portion radially reinforces the free-standing region of the guide flange. This makes it possible to reinforce the highly stressed region of the guide flange and thus reduce the risk of breakage of the guide flange. In particular, an extent of the axially projecting region of the guide flange depends on a size of the undercut.

Further, the reinforcing portion may extend axially over the entire guide flange. That is, the reinforcing portion reinforces not only the highly loaded axially projecting region of the guide flange, but the entire guide flange so that stability of the guide flange can be further increased even in heavily loaded applications, thereby further reducing a risk of breakage of the guide flange. Preferably, the reinforcing portion has a rectangular, trapezoidal, oval, circular, semi-oval and/or semi-circular cross-sectional shape.

According to a further embodiment, the reinforcing portion and the guide flange are formed in one piece. This enables a particularly stable and cost-effective design.

Alternatively, the reinforcing portion and the guide flange can be formed in two parts. Preferably, the reinforcing portion is connected to the guide flange in a force-fit, form-fit and/or material-fit manner. For example, the reinforcing portion can be pressed onto the guide flange or glued, welded or otherwise connected to the guide flange. Preferably, the reinforcing portion is formed as a separate ring element. This makes it possible to retrofit the radial reinforcing portion in a simple manner. In this case, the reinforcing portion can be made of a different material than the guide flange.

According to a further embodiment, the guide portion has a radial thickness h₀ extending from the undercut to the end of the contact surface, the reinforcing portion having a radial thickness h₁ that is 0.2 to 3 times the radial thickness h₀ of the guide portion, h₁=0.2h₀ to 3h₀.

According to a further aspect, a differential gear, in particular for a vehicle such as a truck, having a tapered roller bearing described above is proposed. The differential gear may be, for example, a rear axle gear.

Further advantages and advantageous embodiments are given in the description, the drawings and the claims. In particular, the combinations of features given in the description and drawings are purely exemplary so that the features can also be present individually or in other combinations.

In the following, the invention will be described in more detail with reference to examples of embodiments shown in the drawings. In this context, the examples of embodiment and the combinations shown in the examples of embodiment are purely exemplary and are not intended to define the scope of protection of the invention. This is defined solely by the appended claims.

### BRIEF DESCRIPTION OF THE DRAWINGS

FIG. 1 is a schematic sectional view of a tapered roller bearing according to a first embodiment of the present disclosure.

FIG. 2 is a schematic sectional view of an inner ring of a tapered roller bearing according to a second embodiment of the present disclosure.

FIG. 3 is a schematic sectional view of an inner ring of a tapered roller bearing according to a third embodiment of the present disclosure.

### DETAILED DESCRIPTION

In the following, identical or functionally equivalent elements are identified by the same reference characters.

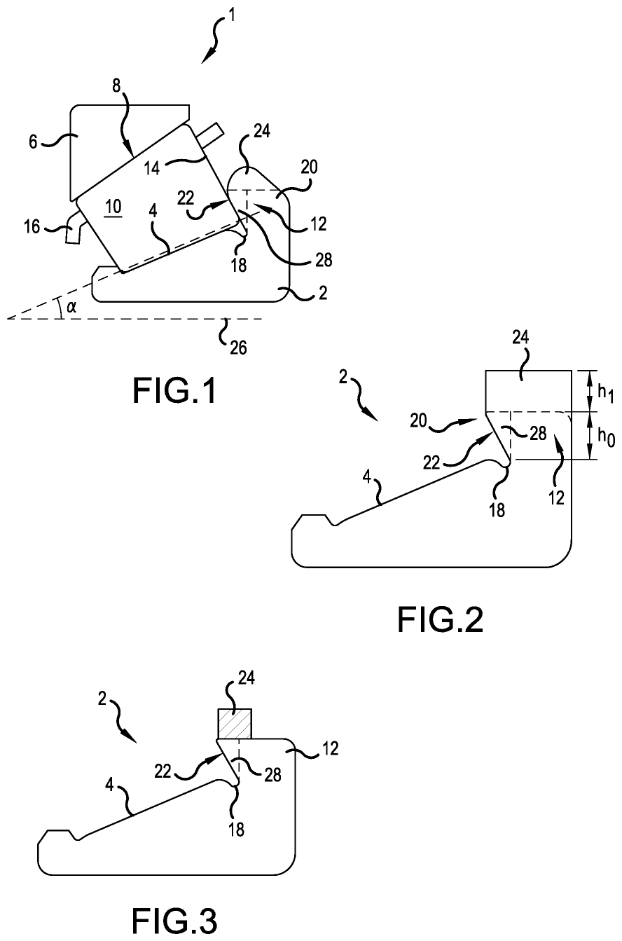

FIG. 1 shows a tapered roller bearing 1 according to a first embodiment. The tapered roller bearing 1 comprises a first ring or inner ring 2 with a first raceway 4 and a second ring or outer ring 6 with a second raceway 8. A row of tapered rollers 10 is arranged between the first and second rings 2, 6, which rollers roll on the first and second raceways 4, 8. Of course, the tapered roller bearing 1 can also have more than one first ring and/or more than one second ring and/or be designed as a multi-row tapered roller bearing.

The first ring 2 is provided with a guide flange 12, which is configured to guide the tapered rollers 10 and to prevent the tapered rollers 10 from jumping out of the bearing 1 at their larger end 14. In this case, the larger end 14 of the tapered rollers 10 rests against the guide flange 12. Furthermore, a cage 16 may also be provided which is configured to keep the tapered rollers 10 evenly spaced in the circumferential direction.

In order to form the raceway 4 on the first ring 2, an undercut or recess 18 is provided between the raceway 4 and the guide flange 12, which allows the surface of the raceway to be machined. In this regard, the undercut defines an axial length of a free-standing region 28 of the guide flange 12 that is not radially supported by the material of the first ring 2. Further, the guide flange 12 has a guide portion 20 that provides a contact surface 22 for contact with the tapered rollers 10 and a reinforcing portion 24 that is not configured to contact the tapered rollers 10. The reinforcing portion 24 radially reinforces the guide flange 12.

The fact that the reinforcing portion 24 radially reinforces the guide flange 12 can reduce a local stress concentration in the region of the undercut 18, thereby reducing the risk of fracture or failure of the guide flange 12. Furthermore, in contrast to a reinforcing portion that projects axially from the guide flange and requires an additional axial installation space, the reinforcing portion that projects radially from the guide flange does not require additional axial installation space; radial installation space required for the reinforced guide flange 12 is usually free so that reinforcing or thickening the guide flange 12 in the radial direction is unproblematic. In FIG. 1, the reinforcing portion 24 reinforces the axially projecting, free-standing region 28 of the guide flange 12 and is integrally formed with the guide flange 12.

One factor that affects the risk of fracture of the guide flange 12 is the inclination of the raceway 4 of the first ring 2. The steeper the raceway 4, the greater the radial load that the guide flange 12 may have to bear and this also increases the risk of fracture of the guide flange 12. In the tapered roller bearing 1, for example, an angle α of the first raceway 4 to an axis of rotation 26 of the tapered roller bearing 1 may be greater than 20°, preferably greater than 25°, most preferably greater than 30°.

FIG. 2 shows a first ring 2 of a tapered roller bearing according to a second embodiment. In contrast to the embodiment of FIG. 1, in the embodiment of FIG. 2 the reinforcing portion 24 extends axially over the entire guide flange 12. That is to say, the reinforcing portion 24 reinforces not only the particularly loaded free-standing region 28 of the guide flange 12, but the entire guide flange 12 so that a stability of the guide flange can be further increased even in heavily loaded applications and thus a risk of breakage of the guide flange 12 can be further reduced. Preferably, the reinforcing portion has a rectangular, trapezoidal, oval, circular, semi-oval and/or semi-circular cross-sectional shape.

The guide portion 20 has a radial thickness h₀ extending from the radially inner portion of the undercut 18 to the end of the contact surface 22. In addition, the reinforcing portion 24 has a radial thickness h₁ that is 0.2 to 3 times the radial thickness h₀ of the guide portion 20, i.e., h₁=0.2h₀ to 3h₀.

FIG. 3 shows a first ring 2 of a tapered roller bearing according to a third embodiment. In contrast to the embodiment of FIGS. 1 and 2, in FIG. 3 the reinforcing portion 24 and the guide flange 12 are formed in two parts. For example, the reinforcing portion 24 may be pressed onto, glued to, welded to, or otherwise connected to the guide flange 12. In FIG. 3, the reinforcing portion 24 is formed as a separate ring element (a reinforcing ring). In this case, the reinforcing portion 24 may be made of a different material than the guide flange.

In summary, reinforcing the guide flange 12 with a reinforcing portion 24 reduces a risk of breakage of the guide flange in a cost-effective manner. By the reinforcing portion 24 radially reinforcing the guide flange, it is not necessary to increase an axial installation space of the tapered roller bearing 1. In other words, the tapered roller bearing 1 can be used in existing bearing arrangements without having to redesign the configuration of the bearing arrangement.

Of course, regardless of whether the reinforcing portion 24 is integrally formed with the guide flange 12 or is formed as a separate element attached to the guide flange 12, the reinforcing portion 24 of the guide flange 12 also allows the axial thickness of the guide flange to be reduced and compensated for by the radial reinforcement so that the stability and/or strength of the guide flange is maintained even when the axial installation space is limited.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved tapered roller bearing rings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMERALS

1 Tapered roller bearing
2 First ring
4 First raceway
6 Second ring
8 Second raceway
10 Taper roller
12 Guide flange
14 Large end
16 Cage
18 Undercut
20 Guide portion
22 Contact surface
24 Reinforcing portion
26 Axis of rotation
28 Freestanding region
α Angle of inclination
h₀ Thickness guide board
h₁ Thickness of reinforcing portion

What is claimed is:

1. A tapered roller bearing, comprising:
a first ring having a first raceway,
a second ring having a second raceway, and
a plurality of tapered rollers between the first and second raceways and configured to roll on the first and second raceways,
wherein the first ring includes a guide flange configured to guide the tapered rollers and an undercut at a junction of the first raceway and the guide flange, the undercut defining an axial length of a free-standing portion of the guide flange that is not radially supported by the material of the first ring,
wherein the guide flange includes a guide portion and a reinforcing portion,
wherein the guide portion has a contact surface configured to contact the tapered rollers,
wherein the contact surface has a radially inner end at the undercut and a radially outer end, and
wherein the reinforcing portion is located radially outward of the radially outer end of the contact surface out of contact with the rollers and is configured to radially reinforce the guide portion.

2. The tapered roller bearing according to claim 1,
wherein a first part of the reinforcing portion is located directly radially outward of the free-standing portion of the guide flange.

3. The tapered roller bearing according to claim 2, wherein a second part of the reinforcing portion extends axially over the entire guide flange.

4. The tapered roller bearing according to claim 3,
wherein the reinforcing portion has a rectangular, trapezoidal, oval, circular, semi-oval and/or semicircular shape in radial cross section.

5. The tapered roller bearing according to claim 2,
wherein the reinforcing portion and the guide flange are integrally formed.

6. The tapered roller bearing according to claim 2,
wherein the reinforcing portion and the guide flange are formed in two parts and meet at a joint.

7. The tapered roller bearing according to claim 6,
wherein the reinforcing portion is a reinforcing ring mounted on a radially outer surface of the free-standing portion of the guide portion of the guide flange.

8. The tapered roller bearing according to claim 6,
wherein the reinforcing portion is connected to the guide flange in a force-fit, form-fit and/or material-bonded manner.

9. The tapered roller bearing according to claim 6,
wherein the reinforcing portion is made of a different material than the guide flange.

10. The tapered roller bearing according to claim 1,
wherein an angle between the first raceway and an axis of rotation of the tapered roller bearing is greater than 20°.

11. The tapered roller bearing according to claim 1,
wherein an angle between the first raceway and an axis of rotation of the tapered roller bearing is greater than 25°.

12. The tapered roller bearing according to claim 1,
wherein an angle between the first raceway and an axis of rotation of the tapered roller bearing is greater than 30°.

13. The tapered roller bearing according to claim 1,
wherein the guide portion has a first radial dimension h₀ extending from the undercut to a radial height of the radially outer end of the contact surface, and
wherein the reinforcing portion has a second radial dimension h₁ 0.2 to 3 times the radial thickness h₀ of the guide portion.

14. The tapered roller bearing according to claim 1,
wherein a first plane perpendicular to the axis of rotation intersects an axial end of the undercut,
wherein a second plane parallel to the axis of rotation and perpendicular to the first plane intersects the radially outer end of the contact surface, and
wherein the reinforcing portion is located radially outward of the second plane.

15. The tapered roller bearing according to claim 14,
wherein the free-standing portion includes the contact surface and is located radially inward of the second plane and to a first side of the first plane.

16. The tapered roller bearing according to claim 15,
wherein the guide portion has a first radial dimension measured radially from a radially innermost portion of the undercut to the second plane and a second radially dimension measured radially from the second plane to a radially outermost portion of the guide flange, and
wherein the second radial dimension is 0.2 to 3 times the first radial dimension.

17. A differential gear having a tapered roller bearing according to claim 1.

18. A vehicle including the differential gear according to claim 17.
